(19) United States
(12) Patent Application Publication
(10) Pub. No.: US 2013/0033869 A1
(43) Pub. Date: Feb. 7, 2013

(54) Interchangeable Decorative Lights

(71) Applicant: DENISE MILLINGTON, SCOTTSDALE, AZ (US)

(72) Inventor: DENISE MILLINGTON, SCOTTSDALE, AZ (US)

(21) Appl. No.: 13/197,245

(22) Filed: Aug. 3, 2011

(51) Int. Cl. F21S 4/00

(52) U.S. Cl. 362/249.16

(57) ABSTRACT

A strand of interchangeable decorative lights comprising: a light strand, where the light strand stretches between a plug and an end; a plurality of light bulbs hanging from the light strand, where the plurality of light bulbs are attached to the light strand with a plurality of sockets; a set of decorative light covers fastened over the plurality of light bulbs; and a plurality of sleeves attached to a top portion of the set of decorative light covers, where the sleeves connect to the plurality of sockets to secure the set of decorative light covers to the light strand. The strand of interchangeable decorative lights may be shaped to reflect a season, a holiday, a cause, a logo, a mascot, and a party. The strand of interchangeable decorative lights may be shaped as a flower, an egg, a candy cane, a ribbon, a shamrock or a variety of other shapes.

### BACKGROUND OF THE INVENTION

1. Field of the Invention

The present invention relates to a strand of lights that includes removable light covers with decorative shapes to enable a user to interchange the particular light cover they desire depending on the season, holiday or celebration.

2. Description of Related Art

During the holidays, especially Christmas, light strands are common accessories used to decorate a house, room, tree, mantle or centerpiece. The lights provide a cheerful and ornamental feature to brighten the immediate area around them. Multiple light strands may be connected depending on the area desired to decorate. For instance, if decorating a small centerpiece only one short strand may be used. Alternatively, if decorating the trimmings on a house, many different long strands may be used until the entire house is covered. Some individuals are creative and place the lights in elaborate arrangements or patterns on their houses. For added appeal, the lights may be colored to set a mood or reflect the particular holiday.

Recently, light shapes have been modified to present a more festive and ornamental look. For example, U.S. Pat. No. 5,012,397 by Jeou N. Tseng discloses a socket and changeable bulb housing snap fastener for Christmas light strings. The light strings include a flower shaped attachment that fits around a mini light bulb to provide mini flowers along the light string. U.S. Pat. No. 6,155,695 by Ira A. Sealy discloses an interchangeable light cover for decorative lighting wherein different colored covers are placed over the light bulbs on a strand of lights. Finally, U.S. Pat. No. 6,971,768 by Alvin M Pepito et al. discloses a decorative lighting system to attach icicle shaped light covers. The icicle shaped covers receive multiple light bulbs along the light strand to illuminate the entire length of the icicle.

While the prior art does allow for changes in the lighting color and shape around the light bulb, it would still be beneficial in the art to provide a light strand with light covers that are shaped to reflect the present holiday or season. It would also be desirable in the art to provide a light strand with shaped light covers that are interchangeable to enable the user to change the cover as their preferences change along the same light strand.

### SUMMARY OF THE INVENTION

In view of the foregoing disadvantages inherent in the prior art, the general purpose of the present invention is to provide a strand of interchangeable decorative lights, configured to include all of the advantages of the prior art, and to overcome the drawbacks inherent therein.

Accordingly, an object of the present invention is to provide a light strand that includes light covers in shapes that reflect the current holiday, season or cause.

Another object of the present invention is to provide a light strand that includes shaped light covers that may be interchanged along the same light strand at will by the user.

Another object of the present invention is to provide a light strand that includes shaped light covers that easily snap onto the individual light bulbs on the strand for easy installation and replacement.

To achieve the above objects, in an aspect of the present invention, a strand of interchangeable decorative lights is described comprising: a light strand, where the light strand stretches between a plug and an end; a plurality of light bulbs hanging from the light strand, where the plurality of light bulbs are attached to the light strand with a plurality of sockets; a set of decorative light covers fastened over the plurality of light bulbs; and a plurality of sleeves attached to a top portion of the set of decorative light covers, where the sleeves connect to the plurality of sockets to secure the set of decorative light covers to the light strand. The strand of interchangeable decorative lights may be shaped to reflect a season, a holiday, a cause, a logo, a mascot, and a party. The strand of interchangeable decorative lights may be shaped as a flower, an egg, a candy cane, a ribbon, a shamrock or a variety of other shapes.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a strand of interchangeable decorative lights in accordance with an exemplary embodiment of the present invention; and

FIG. 2 depicts a perspective view of alternative light covers in accordance with an exemplary embodiment of the present invention.

Like reference numerals refer to like parts throughout the description of several views of the drawings.

### DETAILED DESCRIPTION OF THE DRAWINGS

The present invention relates to a strand of lights that includes removable light covers with decorative shapes to enable a user to interchange the particular light covers they desire depending on the season, holiday or celebration. The present invention provides a strand of interchangeable decorative lights as a way to improve upon standard light strands. The strand of interchangeable decorative lights include a set of decorative light covers that cover the lights on the strand to change the shape, illumination and coloring of the light strand. The decorative light covers are translucent shapes that may comprises shapes such as flags, hearts, eggs and a plurality of other shapes to feature a holiday, season, team or party theme. The strand of interchangeable decorative lights are uniquely designed as a durable, easy to use, safe and convenient way to allow light bulbs to shine brightly through the lightweight cover material.

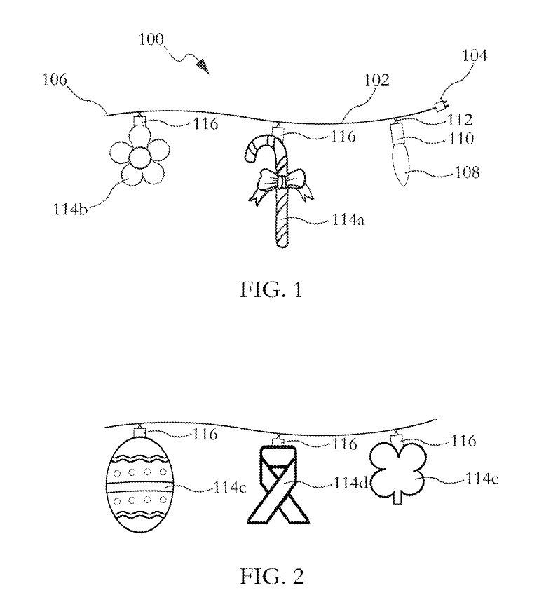

Turning now descriptively to the drawings, referring to FIG. 1, a perspective view of a strand of interchangeable decorative lights (100) is shown in accordance with an exemplary embodiment of the present invention. The strand of interchangeable decorative lights (100) includes a light strand (102) that stretches the entire length of the strand of interchangeable decorative lights (100) from a plug (104) to an end (106). The strand (102) houses the wires that power the plurality of light bulbs (108) that hang from the strand (102). The strand (102) may be covered in a waterproof casing to enable the strand of interchangeable decorative lights (100) to be hung outdoors, and the color of the strand (102) may be black, white, green, brown or the like depending on the objects upon which the strand (102) is hung.

As mentioned above, hung from the strand (102) is a plurality of light bulbs (108) (hereinafter light bulbs). The light bulbs (108) may be conventional light bulbs that are attached to the standard set of decorative light strands. Alternatively, the light bulbs (108) may be the mini-size or LED holiday lights that are commonly hung on Christmas trees or houses. The light bulbs (108) attach into a plurality of sockets (110) (hereinafter sockets) which are in turn attached to the strand (102) with a plurality of wires (112) (hereinafter wires). The wires (112) are connected to the wires that run through the strand (102) to power the light bulbs (108).

Fastened to the light bulbs (108) is a set of decorative light covers (114) (hereinafter decorative light covers). At a top portion of the decorative light covers (114) are a plurality of sleeves (116) (hereinafter sleeves). The decorative light covers (114) are hollow bodies to easily receive the light bulbs (108). The light bulbs (108) are inserted through the sleeves (116) to fit within the decorative light covers (114). The sleeves (116) may snap onto the sockets (110) or alternatively screw on with a set of threads (not shown) to secure the decorative light covers (114) over the light bulbs (108). The decorative light covers (114) are made from a translucent material to enable the light from the light bulb (108) to illuminate through the decorative light covers (114). The translucent material may be a lightweight plastic for durable, easy and safe storage of the decorative light covers (114). On the other hand, the translucent material may be made of glass for brighter illumination and as a high quality ornamental item.

The decorative light covers (114) comprise decorative shapes that may coordinate with the current holiday, season, festivity or cause. For example, as shown in FIG. 1, a set of candy cane covers (114a) may be used during Christmas. Alternatively, a set of flower covers (114b) may be used in a child's room or to celebrate the spring season. The colors and specific shapes for the decorative light covers may change depending on the likes and preferences of the user.

Referring to FIG. 2, alternative decorative light covers (114) are shown as examples of the possibilities of different shapes. FIG. 2 does not illustrate an exhaustive list of possibilities but rather some of the variations that may be used for the decorative light covers (114). As shown, during Easter a set of egg decorative covers (114c) may be used, or during St. Patrick's Day festivities a set of shamrock decorative covers (114e) may be hung. Finally, as a reminder for a cause a set of ribbon decorative covers (114d) may be used, wherein variation is ribbon decorative cover (114d) color symbolize the particular cause. For example, a pink ribbon decorative cover (114d) may symbolize breast cancer while a red ribbon decorative cover (114d) symbolizes AIDS awareness. Still other shapes may be used for the sets; specifically, a flag for the 4^{th} of July or Flag Day, a dreidel for Hanukkah, a bell for a wedding, a party hat, star or cake for a birthday, a snowflake or snowman for winter, a leaf for fall, a skeleton or pumpkin for Halloween, a heart for Valentine's Day, a turkey for Thanksgiving, a Santa, tree or ornament for Christmas, logos business events, mascots for sports gatherings, and a plurality of other shapes and designs commonly used to celebrate and symbolize festivities.

Accordingly, the strand of interchangeable decorative lights (100) allows a user to interchange the decorative light covers (114) depending on the season, holiday, party or simply likes of the user. The same light strand is used to attach a variety of different light cover themes. Therefore the user is provided with a fun and attractive way to decorate their home, dorms or businesses at will throughout the year.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A strand of interchangeable decorative lights comprising:
a light strand, where the light strand stretches between a plug and an end;
a plurality of light bulbs hanging from the light strand, where the plurality of light bulbs are attached to the light strand with a plurality of sockets;
a set of decorative light covers fastened over the plurality of light bulbs; and
a plurality of sleeves attached to a top portion of the set of decorative light covers, where the plurality of sleeves connect to the plurality of sockets to secure the set of decorative light covers to the light strand.

2. The strand of interchangeable decorative lights according to claim 1, wherein the set of decorative lights are shaped to reflect one of at least a season, a holiday, a cause, a logo, a mascot, and a party.

3. The strand of interchangeable decorative lights according to claim 2, wherein the set of decorative lights are shaped as one of at least a flower, an egg, a candy cane, a ribbon and a shamrock.

4. The strand of interchangeable decorative lights according to claim 2, wherein the set of decorative lights are further shaped as one of at least a leaf, a Santa, a turkey, a tree, a flag, a dreidel, a bell, a hat, a star, a cake, a snowflake, a snowman, a skeleton, a pumpkin and a heart.

5. The strand of interchangeable decorative lights according to claim 1, wherein the plurality of sleeves snap onto the plurality of sockets to attach the set of decorative light covers to the light strand.

6. The strand of interchangeable decorative lights according to claim 1, wherein the plurality of sleeves include threads to screw the set of decorative light covers onto the light strand.

7. The strand of interchangeable decorative lights according to claim 1, wherein the set of decorative light covers comprise hollow bodies made of a translucent material.

8. The strand of interchangeable decorative lights according to claim 7, wherein the translucent material is a lightweight plastic.

9. The strand of interchangeable decorative lights according to claim 7, wherein the translucent material is glass.
